(19) United States
(12) Patent Application Publication
(10) Pub. No.: US 2026/0289334 A1
(43) Pub. Date: Sep. 24, 2026

(54) Method and System for Auto-Correcting Factual Errors Using a Personal Knowledge Base

(71) Applicant: Motorola Mobility LLC, Chicago, IL (US)

(72) Inventors: Amit Kumar Agrawal, Bangalore (IN); Nakul Patel, Bangalore (IN); Krishnan Raghavan, Banglore (IN)

(21) Appl. No.: 19/084,276

(22) Filed: Mar. 19, 2025

(51) Int. Cl. G06N 5/022; G06F 16/23

(52) U.S. Cl. CPC G06N 5/022; G06F 16/2365

(57) ABSTRACT

A method in an electronic device includes a user interface receiving user input defining one or more factual entries and one or more processors comparing the one or more factual entries to corresponding factual data obtained from a personal knowledge data store. The one or more processors determine whether there are any inconsistencies between the one or more factual entries and the corresponding factual data obtained from the personal knowledge data store. Where there are inconsistencies between the one or more factual entries and the corresponding factual data obtained from the personal knowledge data store, the one or more processors perform at least one remedial operation to eliminate the inconsistencies between the one or more factual entries and the corresponding factual data obtained from the personal knowledge data store.

### BACKGROUND

### Technical Field

This disclosure relates generally to electronic devices, and more particularly to electronic devices with user interfaces for receiving user input defining factual entries.

### Background Art

In the realm of digital communication, the accuracy of information conveyed is of utmost importance. However, current tools primarily focus on correcting spelling and grammatical errors, neglecting the verification of other factual data. This oversight can lead to significant issues, such as incorrect travel dates, contact details, or addresses, which may result in misunderstandings, missed appointments, or logistical challenges. As users increasingly rely on digital platforms for communication, it would be advantageous to have improved tools that ensure both linguistic and factual accuracy in user-created content.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one or more method steps in accordance with one or more embodiments of the disclosure.

FIG. 2 illustrates one explanatory electronic device in accordance with one or more embodiments of the disclosure.

FIG. 3 illustrates one explanatory method in accordance with one or more embodiments of the disclosure.

FIG. 4 illustrates one explanatory system in accordance with one or more embodiments of the disclosure.

FIG. 5 illustrates one or more method steps in accordance with one or more embodiments of the disclosure.

FIG. 6 illustrates one explanatory electronic device in accordance with one or more embodiments of the disclosure.

FIG. 7 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to receiving, by a user interface, user input defining one or more factual entries, comparing, by one or more processors operable with the user interface, the one or more factual entries to corresponding factual data obtained from a personal knowledge data store, and determining, by the one or more processors, whether there are any inconsistencies between the one or more factual entries and the corresponding factual data obtained from the personal knowledge data store. In one or more embodiments, when there are inconsistencies between the one or more factual entries and the corresponding factual data obtained from the personal knowledge data store, the method steps comprise performing, by the one or more processors, at least one remedial operation to eliminate the inconsistencies between the one or more factual entries and the corresponding factual data obtained from the personal knowledge data store. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of using one or more processors to, in response to the user interface receiving user input creating content comprising factual data, to compare the factual data to other factual data obtained from a personal knowledge data store comprising previously generated or received content to determine whether discrepancies exist between the factual data and the other factual data and, when the discrepancies exist, perform a discrepancy correction operation as described herein. The non-processor circuits may include, but are not limited to, a radio receiver, a radio transmitter, signal drivers, clock circuits, power source circuits, and user input devices.

As such, these functions may be interpreted as steps of a method to perform receiving, by a user interface, user input creating content comprising one or more factual entries, analyzing, by one or more processors operable with the user interface, the user input to identify the factual entries and a context in which they are mentioned, verifying, by the one or more processors, correctness of the factual entries against corresponding factual data obtained from a personal knowledge base, determining, by the one or more processors, whether there are any discrepancies between the factual entries and the corresponding factual data from the personal knowledge base, generating, by the one or more processors, a correction suggestion for any identified discrepancies, and presenting the correction suggestion on the user interface.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, in the realm of digital communication, the accuracy of information conveyed is of utmost importance. Illustrating by example, spelling mistakes are a common occurrence due to the fast-paced nature of typing, distractions, or unfamiliarity with certain words. Embodiments of the disclosure contemplate that these errors can undermine the professionalism and clarity of messages across various platforms, including emails, documents, and informal texts.

Current spell-checking and auto-correct tools have become essential in maintaining accuracy, as they are integrated into word processors, email platforms, and mobile devices to instantly flag errors and offer corrections. However, these systems primarily focus on spelling and grammatical errors, often neglecting the verification of factual information such as travel dates, contact details, and addresses.

As individuals increasingly rely on electronic devices for communication, the potential for errors in factual data, such as dates, times, and contact details, becomes a significant concern. Current tools primarily focus on correcting spelling and grammatical errors, often neglecting the verification of factual information. This oversight can lead to misunderstandings, missed appointments, and logistical challenges, as users may unknowingly share incorrect information.

Existing spell-checking and auto-correct systems have become essential tools for typing, helping users quickly correct spelling and grammatical errors. However, these systems often fall short when verifying factual information. For instance, typing an incorrect travel date can lead to missed flights or reservations, while sharing the wrong phone number may hinder important communications. These errors can create frustration, wasted time, and even financial repercussions, particularly in professional settings where accuracy is of utmost importance.

To illustrating by example, consider Sarah. Sarah, a diligent professional, was meticulously planning a business trip to Vietnam, a journey that was important for her company's expansion into Southeast Asia. In the midst of coordinating logistics, she found herself juggling multiple tasks, including booking flights, arranging accommodations, and scheduling meetings with potential clients.

During a hectic moment, Sarah typed a message in a group chat to her team, stating, “I'll be in Vietnam from December 10th to 17th.” Unbeknownst to her, she had mistakenly entered the wrong dates; her actual travel itinerary was from December 12th to 19th.

This seemingly minor error went unnoticed by her spell-checking software, which was solely focused on correcting spelling and grammatical mistakes, leaving factual inaccuracies unchecked. As a result, her colleague Julia, who was responsible for organizing an important meeting with a significant client, scheduled the meeting for December 11th, a day before Sarah's arrival.

When Sarah received the meeting invitation on December 10th, she was alarmed to discover the oversight. The error not only necessitated a last-minute rescheduling of the meeting, causing frustration and inconvenience for Julia, but it also risked damaging the professional relationship with the client. This incident starkly highlighted the limitations of existing spell-checking tools, which failed to verify factual information, underscoring the need for a more advanced solution that could prevent such costly mistakes in professional settings.

Now consider a story about Emily, a meticulous planner, who was eagerly organizing a surprise birthday party for her close friend, Honey. She envisioned an evening filled with laughter, joy, and cherished memories.

In her excitement, Emily sent out a group chat invitation to all of Honey's friends, intending to inform them that the party was scheduled for March 15th at 6 PM. However, amidst the flurry of preparations and her bustling schedule, she inadvertently typed “March 25th” instead.

As the day of the party approached, Emily was filled with anticipation, imagining the look of surprise on Honey's face. Yet, as the clock struck 6 PM on March 15th, Emily found herself alone at the venue, puzzled by the absence of guests. Only after a frantic check of her calendar did she realize her mistake.

The error, unnoticed by her spell-checking software, had led to a misunderstanding that left Emily disheartened and her friends disappointed. This incident starkly highlighted the limitations of existing spell-checking tools, which failed to verify factual information, underscoring the need for a more advanced solution that could prevent such costly mistakes in personal and professional setting.

Advantageously, embodiments of the disclosure provide method and system addressing these shortcomings by introducing a process for auto-correcting factual errors using a personal knowledge base. In one or more embodiments, this approach leverages data from various sources, such as calendars, contact lists, and email histories, to verify the accuracy of factual entries in user-generated content.

By comparing user input with corresponding factual data from a personal knowledge data store, the system can identify inconsistencies and suggest corrections. This method not only enhances the accuracy of digital communication but also improves the overall user experience by reducing the cognitive load associated with manually verifying factual information.

In one or more embodiments, the solution to the problem of verifying factual information in digital communication involves leveraging a Personal Knowledge Base (PKB) to enhance the functionality of existing spell-check and auto-correct systems. In one or more embodiments, this approach integrates data from various sources such as calendars, contact lists, browsing history, email history, and text message history to verify the accuracy of factual entries in user-generated content.

By monitoring user input, the system identifies factual information, such as dates, times, phone numbers, and addresses, and analyzes the context in which they are mentioned. The system then verifies this information against the user's PKB, providing context-aware suggestions for corrections when discrepancies are detected. This method not only ensures the accuracy of digital communication but also reduces the cognitive load on users by automating the verification process, thereby improving communication efficiency and preventing misunderstandings or logistical issues. Additionally, the system can offer users the option to accept or ignore correction suggestions, and even provide post-transmission editing capabilities, ensuring flexibility and user control over the correction process.

In one or more embodiments, a method implemented in an electronic device enhances the accuracy of user-generated content by auto-correcting factual errors. In one or more embodiments, the process involves receiving user input through a user interface, which defines one or more factual entries. These entries are then compared by one or more processors, operable with the user interface, against corresponding factual data obtained from a personal knowledge data store.

In one or more embodiments, the processors determine whether any inconsistencies exist between the user-defined factual entries and the factual data from the personal knowledge data store. Upon identifying inconsistencies, the processors perform at least one remedial operation to eliminate these inconsistencies, thereby ensuring the factual accuracy of the content. This process leverages the personal knowledge data store, which may include data from various sources such as calendars, contact lists, and email histories, to provide a comprehensive verification process that enhances the reliability of digital communication.

Advantageously, this method enhances the accuracy of user-generated content by integrating a personal knowledge data store, which may include data from calendars, contact lists, and emails, to verify factual information. By automating the detection and correction of factual errors, the method reduces the cognitive load on users, allowing them to focus on content creation without worrying about factual inaccuracies.

This approach not only improves the reliability of digital communication but also minimizes the risk of misunderstandings and logistical errors, which are common when factual data is incorrect. The method's ability to automatically suggest corrections or prompt users for manual adjustments ensures that the content remains accurate and up to date, thereby enhancing the overall user experience and communication efficiency.

In one or more embodiments, an electronic device comprises a user interface and one or more processors operable with the user interface. In one or more embodiments. the processors are configured to respond to user input received through the user interface, which creates content comprising factual data.

In one or more embodiments, the processors compare this factual data to other factual data obtained from a personal knowledge data store, which includes previously generated or received content. This comparison is conducted to determine whether discrepancies exist between the factual data and the other factual data.

In one or more embodiments, when discrepancies are identified, the processors perform a discrepancy correction operation. This operation may involve presenting a prompt on the user interface that identifies the discrepancy and provides a user actuation target, which, when actuated, corrects the discrepancy. The personal knowledge data store may be accessed from a remote electronic device across a network using a communication device integrated within the electronic device, thereby ensuring that the most current and relevant data is utilized for the correction process.

Advantageously, this configuration allows the device to enhance the accuracy of user-generated content by automatically identifying and correcting factual errors. By integrating a personal knowledge data store, which may include data from calendars, contact lists, and emails, the device can provide a comprehensive verification process that enhances the reliability of digital communication.

This setup reduces the cognitive load on users, allowing them to focus on content creation without worrying about factual inaccuracies. Additionally, the ability to automatically suggest corrections or prompt users for manual adjustments ensures that the content remains accurate and up to date, thereby improving the overall user experience and communication efficiency. This approach minimizes the risk of misunderstandings and logistical errors, which are common when factual data is incorrect.

In one or more embodiments, a method implemented in an electronic device involves receiving user input through a user interface, where the input creates content comprising one or more factual entries. In one or more embodiments. the method includes analyzing the user input using one or more processors operable with the user interface to identify the factual entries and the context in which they are mentioned.

In one or more embodiments, the processors verify the correctness of these factual entries against corresponding factual data obtained from a personal knowledge base, which may include data from a calendar application, contact list application, email history, text message history, and other integrated applications. Upon determining any discrepancies between the factual entries and the corresponding factual data from the personal knowledge base, the processors generate a correction suggestion for any identified discrepancies. This correction suggestion is then presented on the user interface, allowing the user to review and address the discrepancies before the content is finalized or transmitted.

Advantageously, this method leverages the integration of data from various applications such as calendar, contact list, email history, and text message history to ensure the accuracy of factual information. By implementing this method, the electronic device can automatically verify factual data in real-time, reducing the likelihood of errors in user-generated content.

This approach enhances the reliability of digital communication by ensuring that factual information, such as dates and contact details, is accurate before the content is finalized or transmitted. The method's ability to generate context-aware correction suggestions allows users to make informed decisions about accepting or rejecting corrections, thereby improving communication efficiency and reducing the cognitive load on users.

This system provides a practical solution to the problem of factual inaccuracies in digital communication, which is not addressed by traditional spell-check and grammar-check tools. Other advantages will be described below. Still others will be obvious to those of ordinary skill in the art having the benefit of this disclosure.

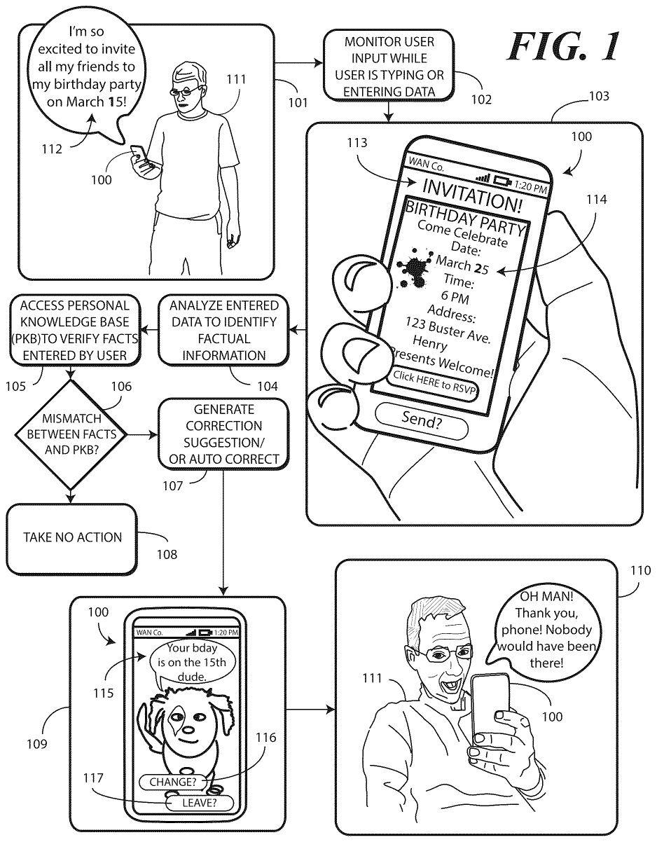

Turning now to FIG. 1, illustrated therein are one or more method steps in accordance with one or more embodiments of the disclosure. At step 101, user 111 of electronic device 100, configured in accordance with one or more embodiments of the disclosure, eagerly anticipates inviting all his friends to an unforgettable birthday celebration on March 15.

The excitement is palpable as he envisions a night filled with laughter, joy, and camaraderie. The party is set to take place in a beautifully decorated venue, adorned with vibrant balloons and twinkling fairy lights that create a magical ambiance. Guests will be treated to a sumptuous feast featuring an array of gourmet dishes, from succulent grilled meats to an assortment of fresh salads and decadent desserts.

As the evening unfolds, the smooth melodies of live jazz music will fill the air, setting an ideal backdrop for lively conversations and spontaneous dance-offs. The highlight of the night promises to be a surprise performance by a renowned jazz band, ensuring that the party is not just a gathering but an epic event that will be remembered for years to come.

At step 101 of FIG. 1, user 111 interacts with the electronic device 100 to create the textual content of an invitation intended for distribution to all of his friends. The user interface of the electronic device 100 is configured to receive user input, which in this instance involves the user typing or dictating the details of the invitation. These details include the date 112 of March 15, which is the actual date of the party.

In this illustrative example, this input includes necessary factual entries such as the date, time, and location of the event. The electronic device 100, equipped with a user-friendly interface, allows user 111 to seamlessly enter this information, ensuring that the invitation is both accurate and complete. The device's interface may include features such as a virtual keyboard, voice recognition capabilities, or touch input, facilitating the efficient creation of the invitation content.

As the user has delivers the user input, step 102 comprises the user interface receiving the user input defining one or more factual entries. Examples of such factual entries include the date, time, and location of the event. Others will be obvious to those of ordinary skill in the art having the benefit of this disclosure. At step 102, the electronic device processes the information, preparing the details for transmission to the intended recipients, thereby ensuring that all friends receive the correct details of the event.

At step 103 of FIG. 1, user 111 inadvertently types the date 114 of the party as March 25 instead of the intended March 15 in the composed invitation 113. This seemingly minor error could lead to significant consequences if the electronic device 100 were not configured in accordance with embodiments of the disclosure.

Indeed, without the system's ability to verify factual data against a personal knowledge base, the incorrect date would remain unchecked, resulting in the invitation being sent with the wrong information. As a result, guests would arrive on the incorrect date, leading to confusion and disappointment.

The host, unaware of the error until the day of the event, would face the embarrassment of an empty venue and the potential strain on personal relationships due to the misunderstanding. Additionally, the logistical arrangements, such as venue bookings and catering, would be misaligned, potentially incurring financial losses and wasted resources. This scenario highlights the necessity for a system that not only corrects spelling and grammatical errors but also ensures the factual accuracy of user-generated content, thereby preventing such adverse outcomes.

Fortunately for our user 111, the electronic device 100 is configured in accordance with embodiments of the disclosure. As such, at step 104 of FIG. 1, the electronic device analyzes the user-entered data of the invitation 113 to identify factual information. In one or more embodiments, this analysis can employ multiple techniques to enhance accuracy and efficiency.

Illustrating by example, one technique involves natural language processing (NLP) algorithms that parse the text to extract entities such as dates, times, and locations. This method allows for the identification of factual data within the context of the message, ensuring that the extracted information is relevant and accurate.

Another technique utilizes machine learning models trained on large datasets to recognize patterns and predict the likelihood of certain data being factual entries. This approach benefits from continuous learning, improving accuracy over time as the system adapts to user-specific language patterns and preferences. Additionally, the system can leverage rule-based algorithms that apply predefined rules to detect factual information, offering a straightforward and computationally efficient solution.

Each of these techniques provides distinct advantages: NLP offers contextual understanding, machine learning provides adaptability and precision, and rule-based algorithms ensure speed and simplicity. By integrating these methods, the system effectively identifies factual information, reducing the risk of errors and enhancing the reliability of digital communication.

At step 105, the one or more processors of the electronic device 100 are configured to access corresponding factual data from a personal knowledge data store to verify the factual information detected from the invitation 113 at step 104. This personal knowledge data store may comprise a variety of data sources, including but not limited to calendaring data, contact lists, email histories, and text message histories, which are integrated into the device's system.

In the context of the present application, a “personal knowledge data store” refers to a digital storage system that collects and organizes various pieces of personal information from different sources you use regularly. Consider this system as a smart, digital assistant that keeps track of important details from the user's life to help the user 111 avoid mistakes when typing or communicating. Here's a basic explanation of the process:

In one or more embodiments, the personal knowledge data store gathers information from places like the user's calendar, contact list, email history, text messages, and other apps the user 111 uses. This could include dates of events, phone numbers, addresses, and other factual details.

In one or more embodiments, when the user 111 types of information, such as a date or an address, decision 106, as described below, checks this information against the stored data. For example, if the user 111 types “March 25th” for a party date, but the calendar shows the party is actually on “March 15th,” the system will notice this discrepancy.

If the system identifies a discrepancy between the input the user 111 provided and the information stored in the personal knowledge data store, the system can propose a correction at step 107. This process aids in maintaining the accuracy of the information the user 111 shares, thereby decreasing the likelihood of misunderstandings or errors.

The processors utilize these data sources to cross-reference the detected factual entries, such as dates, times, and locations, ensuring their accuracy by comparing them against the stored data. This process involves querying the personal knowledge data store for relevant entries that match or closely relate to the detected information, thereby enabling the device to identify any discrepancies or confirm the correctness of the factual data in the invitation. By leveraging this comprehensive data access, the electronic device enhances the reliability of user-generated content, reducing the likelihood of errors and improving communication efficiency.

As will be described below, in some embodiments the user 111 has the option to accept or ignore these suggestions. The system might also allow the user 111 to make corrections even after you've sent a message, giving you a second chance to fix any mistakes. In summary, a personal knowledge data store acts like a personal fact-checker, using the user's own data to help the user 111 communicate more accurately and efficiently.

At decision 106 of FIG. 1, the electronic device 100 employs one or more processors operable with the user interface to compare the factual entries provided by the user with corresponding factual data obtained from a personal knowledge data store. As noted above, this data store may include information from various sources such as calendars, contact lists, email histories, and text message histories, which are integrated into the device's system.

Indeed, in one or more embodiments the personal knowledge data store comprises data obtained from one or more of calendaring data from a calendaring application, contact data from a contact list application, email data from an email application, text data from a text application, and/or other integrated applications operable on the one or more processors of the electronic device 100. In other embodiments, the personal knowledge data store comprises data related to an authorized user of the electronic device obtained from a screen-scraping operation. Of course, a combination of these approaches can be used as well.

Where a screen-scraping operation is employed, in one or more embodiments the screen-scraping is a technique used to extract information from a website or application by simulating a human's interaction with the interface. Imagine you are looking at a webpage and manually copying information from the webpage into a document. Screen-scraping automates this process by using software to “read” the webpage and collect the data required.

In the context of the personal knowledge data store described herein, screen-scraping is used to gather data from various sources that a person interacts with, such as websites or applications. This data might include calendar events, contact information, or email details. The software mimics how a person would navigate and extract this information, then stores the information in a personal knowledge data store. The personal knowledge data store functions like a digital memory bank, keeping track of important details that can be used to verify factual information in communications, such as ensuring the correct date is mentioned in a message.

Screen-scraping is particularly useful when there is no direct way to access the data through an API (Application Programming Interface), which provides a more structured and efficient method of data exchange. However, screen-scraping can present more challenges because the process relies on the layout and structure of the webpage, which can change and potentially disrupt the data extraction process.

At decision 106, the processors execute a comparison operation by cross-referencing the user-defined factual entries, such as dates, times, and locations, against the stored data to ensure their accuracy. In one or more embodiments, this process involves querying the personal knowledge data store for relevant entries that match or closely relate to the detected information, thereby enabling the device to identify any discrepancies or confirm the correctness of the factual data. By leveraging this comprehensive data access, the electronic device enhances the reliability of user-generated content, reducing the likelihood of errors and improving communication efficiency.

Upon determining inconsistencies between the one or more factual entries and the corresponding factual data obtained from the personal knowledge data store, as identified by decision 106, step 107 involves the execution of at least one remedial operation by the one or more processors. Otherwise, step 108 takes no action.

The remedial operation of step 107 is designed to eliminate the identified inconsistencies, thereby ensuring the accuracy of the user-generated content. The processors may perform this operation by presenting a prompt on the user interface that highlights the discrepancies and offers a user actuation target. This target, when actuated by the user, corrects the inconsistencies by aligning the factual entries with the verified data from the personal knowledge data store.

Alternatively, the processors may automatically correct the discrepancies without user intervention, depending on the system's configuration and user preferences. This process not only enhances the reliability of digital communication but also reduces the cognitive load on users by automating the verification and correction of factual information.

In this illustrative example, when an inconsistency is detected between the actual date of the party, March 15, and the user-entered date of March 25, the one or more processors perform a remedial operation at step 109. In this example, this operation involves presenting a prompt 115 on the user interface, which identifies the discrepancy between the factual entry provided by the user and the corresponding factual data retrieved from the personal knowledge data store. The prompt clearly highlights the inconsistency by displaying both the incorrect user input date, March 25, and the correct date, March 15, as stored in the personal knowledge data store. This process allows the user to easily recognize the error and take corrective action, thereby ensuring the accuracy of the information before the information is finalized or transmitted

In step 109 of FIG. 1, the prompt 115 is designed to effectively capture the user's attention by incorporating a whimsical picture of the user's dog, Buster. This engaging visual element serves to draw the user's focus to the prompt, ensuring that the user is immediately aware of the detected inconsistency in the factual entries.

In step 109 of FIG. 1, the prompt 115 effectively identifies at least one factual datum obtained from the personal knowledge data store that serves as a basis for an inconsistency between a factual entry from the content and a corresponding factual datum. In this illustrative example, the factual datum is humorously conveyed through an engaging visual element featuring Buster, the user's dog, who is depicted saying, “Your bday is on the 15th, dude.”

This approach not only highlights the discrepancy between the user-entered date of March 25 and the correct date of March 15, as stored in the personal knowledge data store, but also captures the user's attention in a memorable and user-friendly manner. By presenting the correct factual datum in a relatable and visually appealing format, the prompt ensures that the user is immediately aware of the error, thereby facilitating prompt corrective action and enhancing the overall accuracy of the user-generated content.

Alongside this image, the prompt includes a user actuation target 116, which is strategically positioned to facilitate user interaction. When the user actuates this target, the system automatically eliminates the inconsistencies between the user-defined factual entry of March 25 and the corresponding factual data of March 15 obtained from the personal knowledge data store. This seamless integration of visual engagement and functional interaction not only enhances user experience but also ensures the accuracy of the information being communicated.

In this illustrative example, actuation of the user actuation target 116 of the prompt 115 at step 109 initiates at least one remedial operation by automatically correcting the inconsistencies between the one or more factual entries of the content and the corresponding factual data obtained from the personal knowledge data store. Upon user interaction with the actuation target 116, the system seamlessly aligns the user-defined factual entries with the verified data from the personal knowledge data store, thereby ensuring the accuracy of the content.

In one or more embodiments, this process involves the processors executing a correction operation that updates the erroneous factual entries, such as dates, times, or locations, to match the accurate information stored in the personal knowledge data store. By automating this correction process, the system not only enhances the reliability of digital communication but also reduces the cognitive load on users, allowing them to focus on content creation without the concern of factual inaccuracies. This approach ensures that the content remains accurate and up to date, thereby improving the overall user experience and communication efficiency.

In step 109 of FIG. 1, the prompt 115 not only presents a user actuation target 116 for correcting inconsistencies but also includes an additional user actuation target 117. This target 117 is strategically designed to provide user 111 with the flexibility to override the remedial operation generated at step 107.

When actuated, the user actuation target 117 allows user 111 to bypass the suggested correction, thereby maintaining the original factual entries as initially inputted. This feature is particularly advantageous in scenarios where user 111 intentionally wishes to retain the original data, such as when the discrepancy is known and deliberate or when the user has additional context not captured by the personal knowledge data store. By incorporating this override capability, the system ensures that user 111 retains complete control over the content, thereby enhancing user autonomy and satisfaction while still providing the benefits of automated factual verification.

At step 110, user 111 is elated to discover that the electronic device 100 has successfully corrected the inadvertent typographical error regarding the party's date. Initially, user 111 had mistakenly entered March 25 instead of the intended March 15 for the celebration. Thanks to the advanced capabilities of the electronic device 100, which leverages a personal knowledge data store to verify factual information, the error was promptly identified and corrected.

This intervention ensured that all of user's friends received the accurate invitation, preventing what could have been a lonely and disappointing evening. To conclude the story, as the party unfolded on the correct date, user 111 was surrounded by friends, laughter, and joy, all made possible by the device's ability to seamlessly integrate factual verification into digital communication. This experience highlighted the profound impact of the disclosed embodiments, which not only enhanced the reliability of user-generated content but also safeguarded personal and social engagements from the pitfalls of human error.

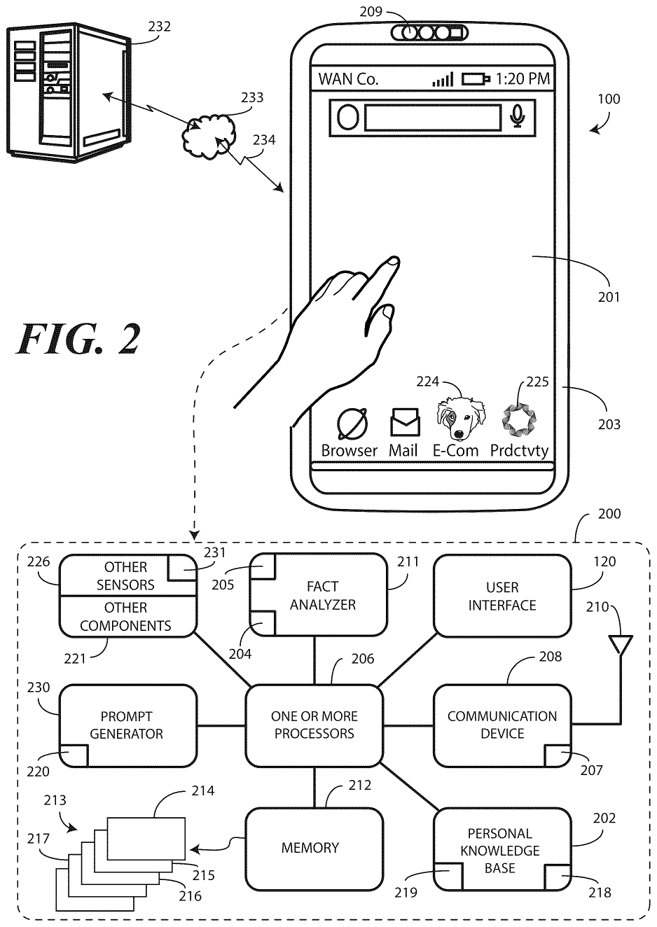

Turning now to FIG. 2, illustrated therein is one electronic device 100 configured in accordance with one or more embodiments of the disclosure. The electronic device 100 of this illustrative embodiment includes a user interface 120. In one or more embodiments, the user interface 120 comprises a display 201, which may optionally be touch-sensitive. The display 201 can serve as a primary user interface 120 of the electronic device 100.

Where the display 201 is touch-sensitive, users can deliver user input to the display 201 by delivering touch input from a finger, stylus, or other objects disposed proximately with the display. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 100 of FIG. 2 includes a housing 203. Features can be incorporated into the housing 203. Examples of features that can be included along the housing 203 include an imager or other image capture device 209, shown as a camera in FIG. 2, or an optional speaker port. A user interface component, which may be a button or touch-sensitive surface, can also be disposed along the housing 203.

A block diagram schematic 200 of the electronic device 100 is also shown in FIG. 2. In one embodiment, the electronic device 100 includes one or more processors 206. In one embodiment, the one or more processors 206 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device.

The application processor and the auxiliary processor(s) can be operable with the various components of the electronic device 100. Each of the application processor and the auxiliary processor(s) can be configured to process and execute executable software code to perform the various functions of the electronic device 100. A storage device, such as memory 212, can optionally store the executable software code used by the one or more processors 206 during operation.

In this illustrative embodiment, the electronic device 100 also includes a communication device 208 that can be configured for wired or wireless communication with one or more other devices or networks. The networks can include a wide area network, a local area network, and/or personal area network. The communication device 208 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 208 can include wireless communication circuitry, one of a receiver, a transmitter, or transceiver, and one or more antennas 210.

In some embodiments, the personal knowledge data store 202 is stored in the electronic device 100. However, in other embodiment the one or more processors 206 access the personalized knowledge data store 202 from a remote electronic device 232 across a network 233 using the communication device 208 and wired or wireless communication 234.

The electronic device 100 can optionally include a near field communication circuit 207 used to exchange data, power, and electrical signals between the electronic device 100 and another electronic device. In one embodiment, the near field communication circuit 207 is operable with a wireless near field communication transceiver, which is a form of radio-frequency device configured to send and receive radio-frequency data to and from the companion electronic device or other near field communication objects.

Where included, the near field communication circuit 207 can have its own near field communication circuit controller in one or more embodiments to wirelessly communicate with companion electronic devices using various near field communication technologies and protocols. The near field communication circuit 207 can include-as an antenna-a communication coil that is configured for near-field communication at a particular communication frequency.

The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 206 can be responsible for performing the primary functions of the electronic device 100. For example, in one embodiment the one or more processors 206 comprise one or more circuits operable to present presentation information, such as images, text, and video, on the display 201. The executable software code used by the one or more processors 206 can be configured as one or more modules 213 that are operable with the one or more processors 206. Such modules 213 can store instructions, control algorithms, and so forth.

In one embodiment, the one or more processors 206 are responsible for running the operating system environment 214. The operating system environment 214 can include a kernel, one or more drivers, and an application service layer 215, and an application layer 216. The operating system environment 214 can be configured as executable code operating on one or more processors or control circuits of the electronic device 100.

The application service layer 215 can be responsible for executing application service modules. The application service modules may support one or more applications 217 or “apps.” Examples of such applications include a cellular telephone application for making voice telephone calls, a web browsing application configured to allow the user to view webpages on the display 201 of the electronic device 100, an electronic mail application configured to send and receive electronic mail, a photo application configured to organize, manage, and present photographs on the display 201 of the electronic device 100, and a camera application for capturing images with the image capture device 209. Collectively, these applications constitute an “application suite.” In one or more embodiments, these applications comprise one or more e-commerce applications 224 and/or productivity applications 225 that allow users to create content comprising factual data using the electronic device 100.

Illustrating by example, in one or more embodiments a user can deliver user input to a productivity application 225 to create content 204 comprising factual data 205. In one or more embodiments, when this happens, the processors 206 compare the factual data 205 to other factual data 218 obtained from a personal knowledge data store 202 comprising previously generated or received content 219 to determine whether discrepancies exist between the factual data 205 and the other factual data 218.

Thereafter, the one or more processors 206 perform a discrepancy correction operation if discrepancies are found. This operation may involve a prompt generator 230 presenting a prompt 220 on the user interface 120 that identifies the discrepancy and provides a user actuation target, which, when actuated, corrects the discrepancy. This ensures that the most current and relevant data is utilized for the correction process.

In one or more embodiments, the one or more processors 206 are responsible for managing the applications and all personal information received from the user interface 120 that is to be used by the e-commerce application 224 and/or productivity application 225 after the electronic device 100 is authenticated as a secure electronic device. The one or more processors 206 can also be responsible for launching, monitoring, and killing the various applications and the various application service modules.

In one or more embodiments, the one or more processors 206 are operable to not only kill the applications, but also to expunge any and all personal data, data, files, settings, or other configuration tools when the electronic device 100 is reported stolen or when the e-commerce application 224 and/or productivity application 225 are used with unauthorized activity to wipe the memory 212 clean of any personal data, preferences, or settings of the person previously using the electronic device 100.

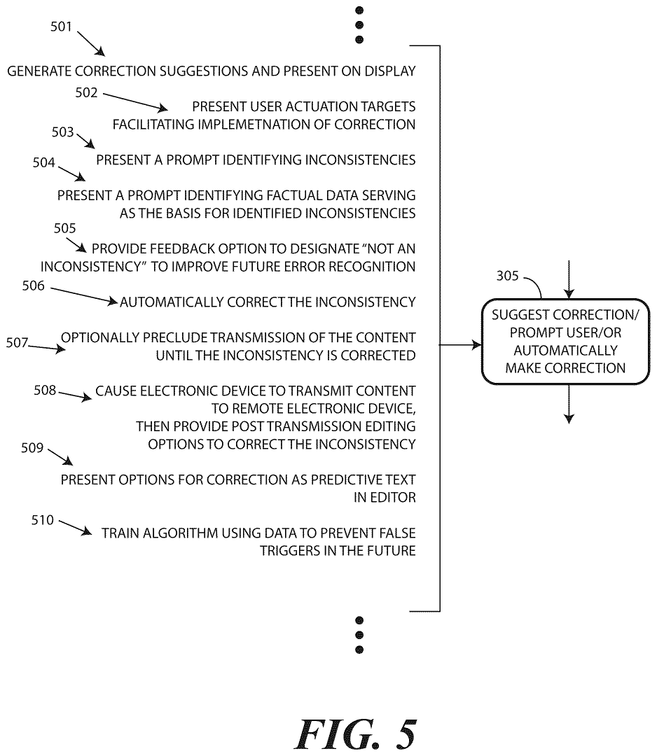

In one or more embodiments, the one or more processors 206 are configured to, in response to the user interface receiving user input creating content comprising factual data, to compare the factual data to other factual data obtained from a personal knowledge data store comprising previously generated or received content to determine whether discrepancies exist between the factual data and the other factual data. In one or more embodiments, when the discrepancies exist, the one or more processors 206 perform a discrepancy correction operation. Examples of such discrepancy correction operations are set forth in FIG. 5 below. Still others will be obvious to those of ordinary skill in the art having the benefit of this disclosure.

The one or more processors 206 can also be operable with other components 221. The other components 221, in one embodiment, include input components, which can include acoustic detectors as one or more microphones. The one or more processors 206 may process information from the other components 221 alone or in combination with other data, such as the information stored in the memory 212 or information received from the user interface.

The other components 221 can include a video input component such as an optical sensor, another audio input component such as a second microphone, and a mechanical input component 231 such as a button. The other components 221 can include one or more sensors 226, which may include key selection sensors, touch pad sensors, capacitive sensors, motion sensors, and switches. Similarly, the other components 221 can include video, audio, and/or mechanical outputs.

The one or more sensors 226 may include, but are not limited to, accelerometers, touch sensors, surface/housing capacitive sensors, audio sensors, and video sensors. Touch sensors may be used to indicate whether the electronic device 100 is being touched at side edges. The other components 221 of the electronic device can also include a device interface to provide a direct connection to auxiliary components or accessories for additional or enhanced functionality and a power source, such as a portable battery, for providing power to the other internal components and allow portability of the electronic device 100.

As noted above, in one or more embodiments the electronic device 100 comprises a prompt generator 230. In one or more embodiments, the prompt generator 230 generates a prompt 220 on the user interface 120 of the electronic device 100 allowing a discrepancy correction operation initiated by the one or more processors 206 to be executed. In one or more embodiments, this prompt 220 is presented where the one or more processors 206 determine that discrepancies exist between the factual data and the other factual data obtained from the personal knowledge data store.

Thus, in one or more embodiments the image capture device 209 captures images or video, while the one or more processors 206 determine whether the factual data in the content created by the user matches the corresponding factual data obtained from the personal knowledge data store 202. In one or more embodiments, where the one or more processors 206 determine that discrepancies exist, the prompt generator 230 presents a prompt 220 on the user interface 120 of the electronic device 100 allowing the discrepancy correction operation to be executed.

In one or more embodiments, the fact analyzer 211 and the prompt generator 230 can be operable with one or more processors 206, configured as a component of the one or more processors 206, or configured as one or more executable code modules operating on the one or more processors 206. In other embodiments, the fact analyzer 211 and the prompt generator 230 can be standalone hardware components operating executable code or firmware to perform their functions. Other configurations for the fact analyzer 211 and the prompt generator 230 will be obvious to those of ordinary skill in the art having the benefit of this disclosure.

It is to be understood that FIG. 2 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components and still be within the scope of the present disclosure.

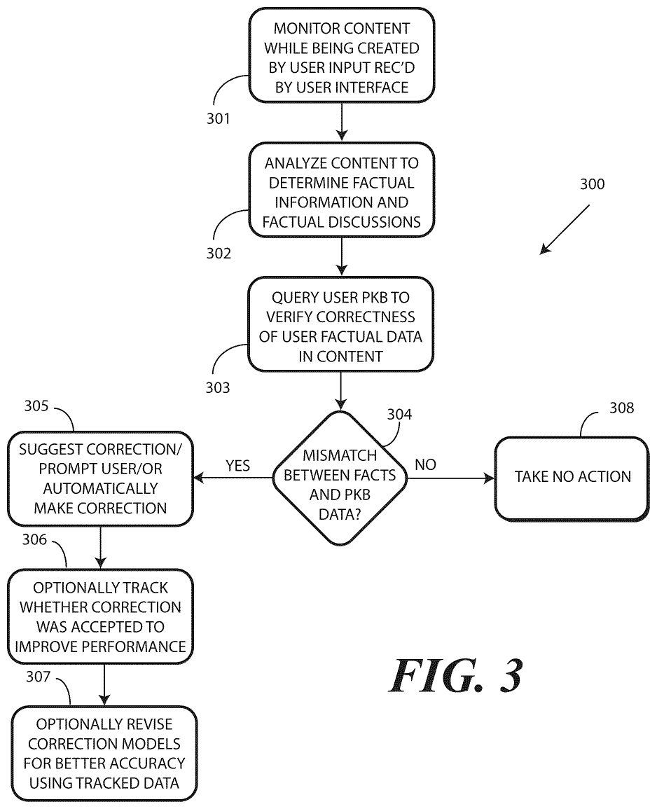

Turning now to FIG. 3, illustrated therein is one explanatory method 300 in accordance with one or more embodiments of the disclosure. Beginning at step 301, the method 300 begins with the monitoring of content as the content is being created through user input received by a user interface of an electronic device.

In one or more embodiments, this step 301 involves the user interface actively receiving user input that generates content, which includes one or more factual entries. The user interface is configured to capture and process this input in real-time, allowing the system to identify and extract factual data such as dates, times, phone numbers, and addresses as they are entered. This real-time monitoring is important for ensuring that the content is accurately captured and that any potential discrepancies can be identified and addressed promptly. By continuously tracking the user input, the system is able to maintain a high level of accuracy and reliability in the content creation process, thereby enhancing the overall user experience and reducing the likelihood of errors in the final output. In one or more embodiments, step 301 comprises receiving, by a user interface, user input creating content comprising one or more factual entries.

At step 302 of the method 300 depicted in FIG. 3, the process involves analyzing the user input received at step 301 by one or more processors operable with the user interface to identify factual entries and the context in which they are mentioned. This analysis plays a role in ensuring the accuracy of the content being created.

For instance, if a user inputs “Meeting with John on April 5th at 3 PM,” the processors identify “April 5th” and “3 PM” as factual entries related to a scheduled event, with “Meeting with John” providing the context. Similarly, when a user types “Dinner reservation for two at 7 PM on Saturday,” the factual entries “7 PM” and “Saturday” are extracted, with the context being a dinner reservation.

Another example includes the input “Flight to New York on June 10th,” where “June 10th” is the factual entry, and the context is a travel plan. By accurately identifying these factual entries and their contexts, the system can effectively verify the information against the personal knowledge base, ensuring that any discrepancies are promptly addressed.

At step 303 of the method 300 depicted in FIG. 3, the process involves verifying the correctness of the factual entries identified in the user input against corresponding factual data obtained from a personal knowledge base. This verification is performed by one or more processors operable with the user interface, which access the personal knowledge base to retrieve relevant data.

The personal knowledge base may include information from various sources such as calendar applications, contact lists, email histories, and text message histories, which are integrated into the system. By cross-referencing the factual entries with this comprehensive data set, the processors can determine whether the entries are accurate or if discrepancies exist. This step ensures that the content being created is factually correct, thereby enhancing the reliability of digital communication and reducing the likelihood of errors that could lead to misunderstandings or logistical issues.

At decision 304 of the method depicted in FIG. 3, the one or more processors are tasked with determining whether any discrepancies exist between the factual entries identified in the user input and the corresponding factual data retrieved from the personal knowledge base. In one or more embodiments, this determination process involves a comprehensive comparison operation, where the processors access the personal knowledge base, which may include data from various sources such as calendar applications, contact lists, email histories, and text message histories.

In one or more embodiments, the processors cross-reference the factual entries, such as dates, times, phone numbers, and addresses, against this data to verify their accuracy. By employing algorithms designed to detect inconsistencies, the processors can identify any mismatches between the user-provided information and the stored factual data. This step is important for ensuring the reliability of the content being created, as it allows the system to flag potential errors and prompt corrective actions, thereby enhancing the overall accuracy and efficiency of digital communication.

If no discrepancies are found, the method 300 moves to step 308 where no action is taken. By contrast, at step 305 of the method 300 depicted in FIG. 3, when discrepancies are identified between the factual entries determined at step 302 and the corresponding factual data retrieved from the personal knowledge base at step 303, the one or more processors are configured to generate a correction suggestion for any identified discrepancies.

In one or more embodiments, step 305 generates a correction suggestion that is then presented to the user through the user interface, allowing the user to review and decide whether to accept or reject the proposed correction. By providing a correction suggestion, the system enhances the accuracy and reliability of user-generated content, thereby reducing the likelihood of errors and improving communication efficiency. In one or more embodiments, this process involves the processors analyzing the nature and context of the discrepancies to formulate a correction suggestion that is contextually relevant and accurate.

The correction suggestion is designed to address the specific inconsistency by proposing an alternative factual entry that aligns with the verified data from the personal knowledge base. Step 305 can be performed in a variety of ways. Turning briefly to FIG. 5, illustrated therein are several ways of performing step 305, each of which can be performed alone or in combination. Others will be obvious to those of ordinary skill in the art having the benefit of this disclosure.

In one or more embodiments, step 305 can comprise generating correction suggestions 501 for presentation on a display. This option helps in the system's ability to enhance user communication by ensuring factual accuracy.

This option is responsible for generating suggestions 501 for correcting factual discrepancies identified in the user input. The option leverages data from the Personal Knowledge Base (PKB) to compare user-entered information against known facts. When a mismatch is detected, the component formulates a correction suggestion, which is then presented on the device's display. This process involves algorithms that analyze the context and content of the user input to ensure that the suggestions are relevant and accurate. The display of these suggestions is designed to be intuitive, allowing users to easily understand and act upon the proposed corrections.

In other option, step 305 can preset user actuation targets 502 facilitating implementation of the correction. This option can work in conjunction with the correction suggestions 501 generated by one or more processors.

Illustrating by example, once a correction suggestion 501 is displayed, the user actuation targets 502 provide interactive elements on the user interface. In one or more embodiments, these targets are designed to facilitate user interaction, allowing users to accept or reject the suggested corrections with ease. The implementation of these targets plays a role in user engagement, as the targets provide a seamless way for users to correct factual errors without disrupting their workflow. The design of these targets is user-friendly, ensuring that users can quickly and efficiently make decisions regarding the suggested corrections.

Another option for step 305 presents a prompt 503 identifying the inconsistencies to serve as an important alert mechanism within the system. When a factual inconsistency is detected, this component generates a prompt 503 that clearly identifies the nature of the inconsistency.

In one or more embodiments, the prompt 503 is designed to capture the user's attention and provide detailed information about the discrepancy, including the specific data points that are in conflict. This component ensures that users are immediately aware of potential errors in their input, allowing them to take corrective action before the information is finalized or transmitted. The prompt 503 is a part of the user interface, providing a clear and concise notification that aids in maintaining the accuracy of user-generated content.

Another option for step 305 is to present a prompt 504 identifying the factual data that served as the basis for the identified inconsistency. This prompt 504 expands on the functionality of prompt 503 by providing additional context for the identified discrepancies.

This component not only alerts users to inconsistencies but also presents the factual data from the PKB that serves as the basis for the correction suggestion. By displaying this information, users gain a better understanding of why a particular correction is being suggested, which enhances their ability to make informed decisions. This transparency is important for user trust and engagement, as it allows users to verify the accuracy of the system's suggestions against their own knowledge and records.

In some embodiments, step 305 can facilitate user feedback 505 to designate identified inconsistencies as not inconsistencies at all to improve future error recognition. This option introduces a feedback mechanism that empowers users to influence the system's learning process.

When users encounter a correction suggestion that they believe is incorrect or unnecessary, they can use this option to provide feedback indicating that the identified inconsistency is not actually an error. This feedback is then used to refine the system's algorithms, improving the ability to recognize true discrepancies in the future. By incorporating user feedback, the system becomes more adaptive and accurate over time, enhancing overall effectiveness in ensuring factual accuracy.

In some embodiments, step 305 can automatically correct 506 the inconsistency. This option offers an automated solution for correcting factual errors without requiring user intervention. This component is particularly useful in scenarios where the system is highly confident in the accuracy of the correction suggestion. By automatically implementing the correction, the system streamlines the user experience, reducing the cognitive load on users and allowing them to focus on content creation. The automation of corrections is governed by predefined rules and confidence thresholds, ensuring that only the most certain corrections are applied without user input.

In some situations, step 305 can preclude transmission 507 of content until the inconsistency is corrected. This option acts as a safeguard to prevent the dissemination of inaccurate information.

When a factual inconsistency is detected, this component can halt the transmission of the content until the user addresses the discrepancy. This feature is particularly beneficial in professional and sensitive communication contexts, where accuracy is of great importance. By preventing the transmission of potentially erroneous content, the system helps maintain the integrity and reliability of user communications.

In other situations, step 305 can facilitate editing after transmission 508. This option extends the system's functionality by allowing for post-transmission corrections. Thus, in one or more embodiments step 305 comprises causing, by the one or more processors, a communication device of the electronic device to transmit the content to a remote electronic device across a network, wherein the at least one remedial operation comprises performing a post transmission editing operation on the content.

After content is sent, users may still receive prompts to correct any identified inconsistencies. This component ensures that even after transmission, users have the opportunity to amend factual errors, thereby maintaining the accuracy of the information shared. This feature is particularly useful in dynamic communication environments where information may need to be updated or corrected after initial transmission.

In some embodiments, step 305 can present options for correction as predictive text 509 in an editor. This option enhances the user experience by providing real-time correction suggestions as users type, similar to predictive text features found in modern text editors. By offering corrections in this manner, users can seamlessly incorporate accurate information into their content without interrupting their workflow. This integration of predictive text with factual correction suggestions represents a significant advancement in user interface design, promoting both efficiency and accuracy.

Feedback 510 can be received to train the algorithm to prevent false triggers in the future. This option focuses on the ongoing enhancement of the system's accuracy through machine learning. By analyzing user interactions and feedback, this component refines the system's algorithms to reduce the occurrence of false triggers—instances where the system incorrectly identifies a factual inconsistency. This continuous training process helps the system become more precise over time, improving the ability to accurately identify and correct factual errors. The use of machine learning in this context highlights the system's adaptability and dedication to providing users with reliable and accurate communication tools.

Turning now back to FIG. 3, such feedback (510) can be received at step 306. Accordingly, in one or more embodiments step 306 comprises receiving, by the user interface, user feedback in response to performance of the at least one remedial operation. Step 307 can then comprise updating, by the one or more processors, the personal knowledge data store as a function of the user feedback to improve future remedial operations. In one or more embodiments, the user feedback indicates whether a correction identified by the at least one remedial operation was accepted, rejected, or ignored.

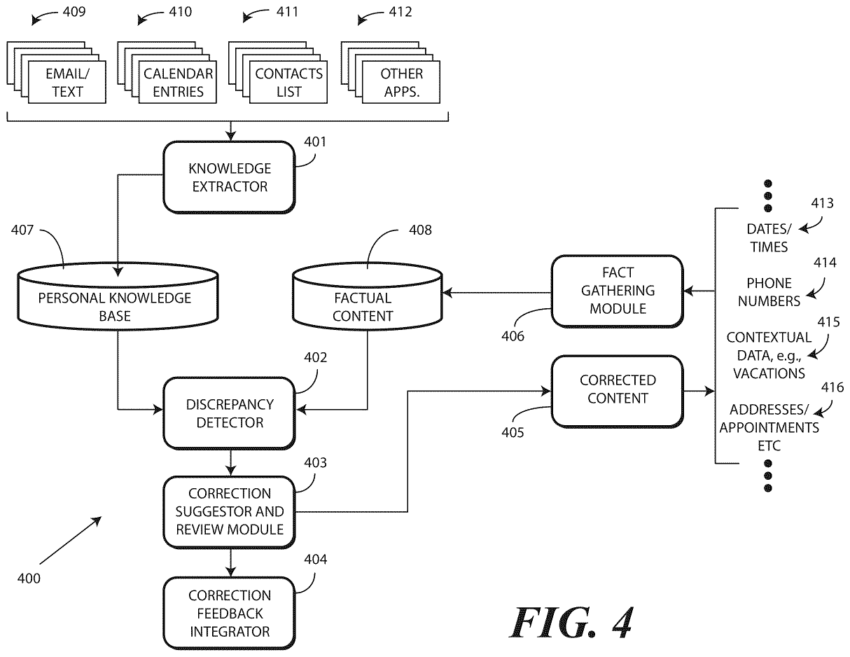

Turning now to FIG. 4, illustrated therein is one explanatory system 400 in accordance with one or more embodiments of the disclosure. The system 400 includes a knowledge extractor 401, a discrepancy detector 402, and a correction suggester and review module 403, each of which are operable with a personal knowledge base.

In one or more embodiments, the knowledge extractor 401 is responsible for gathering and processing data from various sources to build a comprehensive personal knowledge base (PKB) 407. This component interfaces with multiple data repositories, such as email/texts 409, calendar entries 410, contact lists 411, and other applications 412, to extract relevant factual information.

In one or more embodiments, the knowledge extractor 401 employs advanced algorithms to parse and interpret data, ensuring that the PKB 407 is populated with accurate and up-to-date information. By doing so, the knowledge extractor 401 enables the system to have a robust foundation for verifying factual content against user input, thereby enhancing the reliability of the auto-correction process.

In one or more embodiments, the knowledge extractor 401 monitors various data sources, such as email/texts 409, calendar entries 410, contact lists 411, and other applications 412, to identify and extract new factual information. By maintaining an up-to-date PKB 407, the knowledge extractor 401 ensures that the system has access to the most relevant data for verifying user input, thereby enhancing the accuracy and reliability of the correction process.

In one or more embodiments, the discrepancy detector 402 functions as the system's analytical engine, tasked with identifying inconsistencies between the factual content 408 provided by the user and the data stored in the PKB 407. In one or more embodiments, the discrepancy detector 402 operates by cross-referencing user-entered data, such as dates, times, phone numbers, and addresses, against the verified information in the PKB 407.

In one or more embodiments, the discrepancy detector 402 utilizes sophisticated comparison algorithms to detect mismatches, which are important for triggering the correction process. The ability of the discrepancy detector 402 to accurately identify discrepancies ensures that the system can effectively prompt users to correct potential errors, thereby maintaining the integrity of the communication.

The correction suggestion and review module 403 is designed to generate and present correction suggestions to the user when discrepancies are detected by the discrepancy detector 402. In one or more embodiments, this module leverages the contextual data and factual information from the PKB 407 to formulate suggestions that are both relevant and accurate. In one or more embodiments, the module presents these suggestions to the user in an intuitive manner, often through prompts or notifications, allowing the user to review and accept or reject the proposed corrections. The design of the module ensures that users are actively engaged in the correction process, thereby enhancing the overall user experience and communication accuracy.

The correction feedback integrator 404 is instrumental in refining the system's accuracy over time. The integrator collects user feedback on the correction suggestions provided by the correction suggestion and review module 403, tracking whether users accept or reject the proposed changes. This feedback is then used to update and improve the system's correction models, ensuring that future suggestions are more precise and contextually appropriate. By incorporating user feedback, the correction feedback integrator 404 enables the system to learn and adapt, thereby continuously enhancing its performance and reliability.

The corrected content 405 represents the final output of the system after the correction process has been completed. The final output is the result of the user's interaction with the correction suggestions provided by the correction suggestion and review module 403, as well as any automatic corrections made by the system. The corrected content 405 is verified against the PKB 407 to ensure factual accuracy before being finalized. This component plays an important role in ensuring that the communication remains clear, professional, and free from factual errors, thereby enhancing the overall quality of the user-generated content.

The fact gathering module 406 is responsible for identifying factual content 408 defined by user input entering content at a user interface. The fact gathering module 406 monitors user created content for various types of factual content 408, examples of which include dates, date ranges, and times 413, phone numbers 414, contextual data 415, such a vacation dates, and appointments and addresses 416. These factual content 408 are illustrative only, as others will be obvious to those of ordinary skill in the art having the benefit of this disclosure.

The personal knowledge base 407 serves as the central repository of factual information used by the system to verify user input. This repository is populated with data extracted by the knowledge extractor 401 and is used to compare information to the factual content 408 continuously gathered by the fact gathering module 406. The PKB 407 contains a wide range of information, including dates, times, phone numbers, addresses, and contextual data such as vacations and appointments. This comprehensive database serves as the foundation for the system's ability to detect discrepancies and provide accurate correction suggestions, thereby ensuring the integrity of the user-generated content.

The factual content 408 refers to the user-entered data that is subject to verification by the system. This content includes various types of factual information, such as dates, times, phone numbers, and addresses, which are extracted and analyzed by the system to ensure their accuracy. The factual content 408 is compared against the data stored in the PKB 407 by the discrepancy detector 402 to identify any inconsistencies. By accurately identifying and verifying the Factual Content 408, the system can effectively prompt users to correct potential errors, thereby maintaining the integrity of the communication.

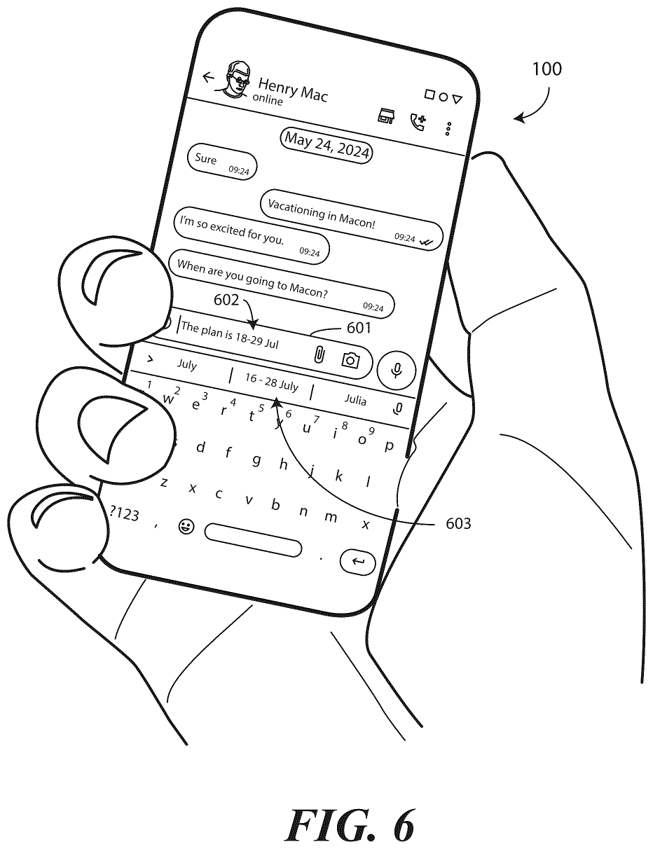

Turning now to FIG. 6, illustrated therein is one explanatory electronic device 100 operating in accordance with one or more embodiments of the disclosure. As previously described, the electronic device 100 includes a user interface and one or more processors operable with the user interface. In one or more embodiments, the one or more processors are configured to, in response to the user interface receiving user input creating content comprising factual data, to compare the factual data to other factual data obtained from a personal knowledge data store comprising previously generated or received content to determine whether discrepancies exist between the factual data and the other factual data. In one or more embodiments, when the discrepancies exist the one or more processors perform a discrepancy correction operation.

In FIG. 6, a user of the electronic device 100 is depicted engaging in a lively text conversation with Henry Mac, enthusiastically sharing plans for an upcoming vacation to Macon, Georgia. This destination, recently highlighted by the Wall Street Journal as one of the ten most recommended places to visit on earth, has captured the user's imagination with its rich history and vibrant cultural scene.

The user is particularly excited about exploring Macon's renowned music heritage, including the legendary Capricorn Sound Studios, which played an influential role in the development of Southern rock. Additionally, the user looks forward to experiencing the city's charming architecture and indulging in its celebrated Southern cuisine. This trip promises not only a relaxing getaway but also an opportunity to immerse in the distinctive blend of tradition and modernity that Macon offers, making the journey a highly anticipated adventure.

In this illustrative embodiment, during this exchange Henry inquires about the user's travel dates. The user, filled with excitement about this thrilling and upcoming trip to Macon, Georgia, delivers user input defining content 601 having factual data 602 in the form of a date range. Sadly, in the midst of this enthusiastic interaction, the user inadvertently inputs an incorrect date range into the user interface, stating that the trip will occur from July 18th to July 29^{th}, when the actual travel dates are July 16th to July 29th. This error, unnoticed by conventional spell-checking tools, highlights the need for a system that not only corrects spelling and grammatical errors but also verifies factual information against a personal knowledge base.

Advantageously, since the electronic device 100 is configured in accordance with one or more embodiments of the disclosure, the one or more processors of the electronic device 100 leverage data from the user's calendar and other integrated applications to detect such discrepancies and suggest corrections, thereby ensuring the accuracy of digital communication and preventing potential misunderstandings.

Indeed, in this embodiment the one or more processors have found in the actual trip dates are July 16-29. The one or more processors of the device, configured in accordance with the present disclosure, detect a discrepancy between the entered dates and the actual travel dates stored in the user's personal knowledge base (PKB). The PKB, which integrates data from various sources such as the user's calendar application, email history, and text message history, contains the correct travel dates of July 16-28.

In this illustrative example, the calendar application operating on the one or more processors had an entry for a flight booking confirmation email received on June 1st, which detailed the itinerary as departing on July 16th and returning on July 28th. By cross-referencing this information, the processors identify the inconsistency and generate a correction suggestion, prompting the user to amend the travel dates to reflect the accurate schedule. This process not only ensures the accuracy of the user's communication but also prevents potential misunderstandings or logistical issues that could arise from sharing incorrect travel information.

In FIG. 6, the one or more processors are configured to perform a discrepancy correction operation by presenting another date range 603 on the user interface. This other date range 603 is derived from the corresponding factual data obtained from the personal knowledge base, ensuring that the correction is context aware.

The processors analyze the user input to identify any discrepancies between the entered date range and the factual data stored in the personal knowledge base, which may include data from calendar applications, email histories, and other integrated sources. Upon detecting a discrepancy, the processors generate a prompt that displays the suggested correction, i.e., the other date range 603, on the user interface.

This prompt is designed to facilitate user interaction by providing options to either accept or reject the correction suggestion, thereby allowing the user to make an informed decision based on the context provided by the personal knowledge base. This approach not only enhances the accuracy of user-generated content but also improves the overall user experience by reducing the cognitive load associated with manually verifying factual information.

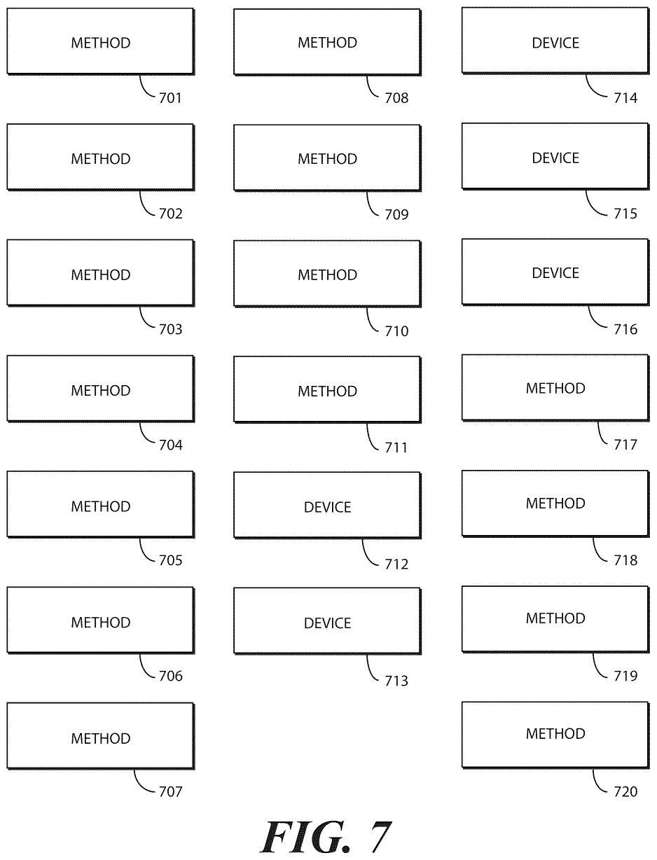

Turning now to FIG. 7, illustrated therein are various embodiments of the disclosure. The embodiments of FIG. 7 are shown as labeled boxes in FIG. 7 due to the fact that the individual components of these embodiments have been illustrated in detail in FIGS. 1-6, which precede FIG. 7. Accordingly, since these items have previously been illustrated and described, their repeated illustration is no longer essential for a proper understanding of these embodiments. Thus, the embodiments are shown as labeled boxes.

At 701, a method in an electronic device comprises receiving, by a user interface, user input defining one or more factual entries. At 701, the method comprises comparing, by one or more processors operable with the user interface, the one or more factual entries to corresponding factual data obtained from a personal knowledge data store.

At 701, the method comprises determining, by the one or more processors, whether there are any inconsistencies between the one or more factual entries and the corresponding factual data obtained from the personal knowledge data store. At 701, where there are inconsistencies between the one or more factual entries and the corresponding factual data obtained from the personal knowledge data store, the method comprises performing, by the one or more processors, at least one remedial operation to eliminate the inconsistencies between the one or more factual entries and the corresponding factual data obtained from the personal knowledge data store.

At 702, the at least one remedial operation of 701 comprises presenting a prompt on the user interface identifying the inconsistencies between the one or more factual entries of the content and the corresponding factual data obtained from the personal knowledge data store. At 703, the prompt of 702 comprises a user actuation target that, when actuated, eliminates the inconsistencies between the one or more factual entries of the content and the corresponding factual data obtained from the personal knowledge data store. At 704, the prompt of 702 identifies at least one factual datum obtained from the personal knowledge data store serving as a basis for an inconsistency between a factual entry from the content and a corresponding factual datum obtained from the personal knowledge data store.

At 705, the at least one remedial operation of 701 comprises automatically correcting the inconsistencies between the one or more factual entries of the content and the corresponding factual data obtained from the personal knowledge data store. At 706, the one or more factual entries of 701 comprise one or more of dates, times, phone numbers, and/or addresses. At 707, the personal knowledge data store of 701 comprises data obtained from one or more of calendaring data from a calendaring application, contact data from a contact list application, email data from an email application, text data from a text application, and/or other integrated applications operable on the one or more processors.

At 708, the method of 701 further comprises causing, by the one or more processors, a communication device of the electronic device to transmit the content to a remote electronic device across a network, wherein the at least one remedial operation comprises performing a post transmission editing operation on the content. At 709, the personal knowledge data store of 701 comprises data related to an authorized user of the electronic device obtained from a screen-scraping operation.

At 710, the method of 701 further comprises receiving, by the user interface, user feedback in response to performance of the at least one remedial operation. At 710, the method comprises updating, by the one or more processors, the personal knowledge data store as a function of the user feedback to improve future remedial operations. At 711, the user feedback of 710 indicates whether a correction identified by the at least one remedial operation was accepted, rejected, or ignored.

At 712, an electronic device comprises a user interface and one or more processors operable with the user interface. At 712, the one or more processors are configured to, in response to the user interface receiving user input creating content comprising factual data, to compare the factual data to other factual data obtained from a personal knowledge data store comprising previously generated or received content to determine whether discrepancies exist between the factual data and the other factual data. At 712, when the discrepancies exist, the one or more processors perform a discrepancy correction operation.

At 713, the factual data of 712 comprises a date range and the other factual data comprises another date range that is different from the date range. At 714, the discrepancy correction operation of 713 comprises presenting the another date range on the user interface.

At 715, the discrepancy correction operation of 712 operation results in a prompt being presented on the user interface identifying at least one discrepancy and providing a user actuation target that, when actuated, corrects the at least one discrepancy. At 716, the electronic device of 712 further comprises a communication device. At 716, the one or more processors access the personalized knowledge data store from a remote electronic device across a network using the communication device.

At 717, a method in an electronic device comprises receiving, by a user interface, user input creating content comprising one or more factual entries. At 717, the method comprises analyzing, by one or more processors operable with the user interface, the user input to identify the factual entries and a context in which they are mentioned.

At 717, the method comprises verifying, by the one or more processors, correctness of the factual entries against corresponding factual data obtained from a personal knowledge base. At 717, the method comprises determining, by the one or more processors, whether there are any discrepancies between the factual entries and the corresponding factual data from the personal knowledge base.

At 717, the method comprises generating, by the one or more processors, a correction suggestion for any identified discrepancies. At 7171, the method comprises presenting the correction suggestion on the user interface.

At 718, the personal knowledge base of 717 comprises data from one or more of a calendar application, contact list application, an email history, a text message history, and/or other integrated applications operable on the one or more processors. At 719, the method of 717 further comprises precluding transmission of the content until the discrepancies are corrected.

At 720, the correction suggestion of 717 is context aware. At 720, the correction suggestion of 717 is based on the corresponding factual data obtained from the personal knowledge base, configured as a prompt, and facilitates acceptance or rejection of the correction suggestion.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in one embodiment the electronic device comprises a user interface that is a touchscreen display, allowing users to interact directly with the device by tapping or swiping to input factual data. In another embodiment, the user interface could be a voice-activated system, enabling users to input data through spoken commands, which the device then processes using speech recognition technology.

Additionally, the one or more processors in the electronic device may vary in configuration. For instance, they could be a single processing unit for basic operations or multiple processing units for handling more complex tasks and data processing efficiently.

The personal knowledge data store could be locally stored on the device, ensuring quick access and processing, or it could be cloud-based, allowing for more extensive data storage and retrieval capabilities. Additionally, the discrepancy correction operation could be implemented in various ways, such as through a simple notification alerting the user to discrepancies, or through a more sophisticated system that automatically suggests corrections based on historical data patterns.

The communication device within the electronic device might support different types of network connections, such as Wi-Fi, cellular, or Bluetooth, to facilitate seamless data exchange with remote devices. These embodiments demonstrate the adaptability of the system to different user preferences and technological environments while maintaining the fundamental functionality of identifying and correcting discrepancies in factual data.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
receiving, by a user interface, user input defining one or more factual entries;
comparing, by one or more processors operable with the user interface, the one or more factual entries to corresponding factual data obtained from a personal knowledge data store;
determining, by the one or more processors, whether there are any inconsistencies between the one or more factual entries and the corresponding factual data obtained from the personal knowledge data store; and
where there are inconsistencies between the one or more factual entries and the corresponding factual data obtained from the personal knowledge data store, performing, by the one or more processors, at least one remedial operation to eliminate the inconsistencies between the one or more factual entries and the corresponding factual data obtained from the personal knowledge data store.

2. The method of claim 1, wherein the at least one remedial operation comprises presenting a prompt on the user interface identifying the inconsistencies between the one or more factual entries and the corresponding factual data obtained from the personal knowledge data store.

3. The method of claim 2, wherein the prompt comprises a user actuation target that, when actuated, eliminates the inconsistencies between the one or more factual entries and the corresponding factual data obtained from the personal knowledge data store.

4. The method of claim 2, wherein the prompt identifies at least one factual datum obtained from the personal knowledge data store serving as a basis for an inconsistency between a factual entry and a corresponding factual datum obtained from the personal knowledge data store.

5. The method of claim 1, wherein the at least one remedial operation comprises automatically correcting the inconsistencies between the one or more factual entries and the corresponding factual data obtained from the personal knowledge data store.

6. The method of claim 1, wherein the one or more factual entries comprise one or more of dates, times, phone numbers, and/or addresses.

7. The method of claim 1, wherein the personal knowledge data store comprises data obtained from one or more of calendaring data from a calendaring application, contact data from a contact list application, email data from an email application, text data from a text application, and/or other integrated applications operable on the one or more processors.

8. The method of claim 1, further comprising causing, by the one or more processors, a communication device of the electronic device to transmit the factual entries to a remote electronic device across a network, wherein the at least one remedial operation comprises performing a post transmission editing operation on the factual entries.

9. The method of claim 1, wherein the personal knowledge data store comprises data related to an authorized user of the electronic device obtained from a screen-scraping operation.

10. The method of claim 1, further comprising:
receiving, by the user interface, user feedback in response to performance of the at least one remedial operation; and
updating, by the one or more processors, the personal knowledge data store as a function of the user feedback to improve future remedial operations.

11. The method of claim 10, wherein the user feedback indicates whether a correction identified by the at least one remedial operation was accepted, rejected, or ignored.

12. An electronic device, comprising:
a user interface; and
one or more processors operable with the user interface;
wherein the one or more processors are configured to, in response to the user interface receiving user input creating content comprising factual data, to compare the factual data to other factual data obtained from a personal knowledge data store comprising previously generated or received content to determine whether discrepancies exist between the factual data and the other factual data and, when the discrepancies exist, perform a discrepancy correction operation.

13. The electronic device of claim 12, wherein the factual data comprises a date range and the other factual data comprises another date range that is different from the date range.

14. The electronic device of claim 13, wherein the discrepancy correction operation comprises presenting the another date range on the user interface.

15. The electronic device of claim 12, wherein the discrepancy correction operation results in a prompt being presented on the user interface identifying at least one discrepancy and providing a user actuation target that, when actuated, corrects the at least one discrepancy.

16. The electronic device of claim 12, further comprising a communication device, wherein the one or more processors access the personalized knowledge data store from a remote electronic device across a network using the communication device.

17. A method in an electronic device, the method comprising:
receiving, by a user interface, user input creating content comprising one or more factual entries;
analyzing, by one or more processors operable with the user interface, the user input to identify the factual entries and a context in which they are mentioned;
verifying, by the one or more processors, correctness of the factual entries against corresponding factual data obtained from a personal knowledge base;
determining, by the one or more processors, whether there are any discrepancies between the factual entries and the corresponding factual data from the personal knowledge base;
generating, by the one or more processors, a correction suggestion for any identified discrepancies; and
presenting the correction suggestion on the user interface.

18. The method of claim 17, wherein the personal knowledge base comprises data from one or more of a calendar application, contact list application, an email history, a text message history, and/or other integrated applications operable on the one or more processors.

19. The method of claim 17, further comprising precluding transmission of the content until the discrepancies are corrected.

20. The method of claim 17, wherein the correction suggestion is context-aware and based on the corresponding factual data obtained from the personal knowledge base, configured as a prompt, and facilitates acceptance or rejection of the correction suggestion.
